(19) United States
(12) Patent Application Publication
(10) Pub. No.: US 2011/0066446 A1
(43) Pub. Date: Mar. 17, 2011

(54) METHOD, APPARATUS AND COMPUTER PROGRAM PRODUCT FOR PROVIDING A DISTRIBUTED REGISTRATION MANAGER

(76) Inventors: Arien Malec, Oakland, CA (US); Kenneth A. Tarkoff, Orinda, CA (US); Susannah D'Oench, San Francisco, CA (US)

(21) Appl. No.: 12/560,107

(22) Filed: Sep. 15, 2009

(51) Int. Cl. G06Q 10/00

(52) U.S. Cl. 705/2

(57) ABSTRACT

A method for providing distributed registration management may include receiving, from a first health system entity, an indication of a healthcare registration event intended to register a patient for an event at a second health system entity in which the patient has a first patient identifier associated with the first health system entity, providing a second patient identifier associated with the second health system entity that correlates to the first patient identifier, and coordinating, via processing circuitry, registration of the second patient identifier for the registration event with the second health system entity. A corresponding computer program product and apparatus are also provided.

### TECHNOLOGICAL FIELD

Embodiments of the present invention relate generally to healthcare management solutions and, more particularly, relate to a mechanism by which registrations may be managed across a plurality of separate healthcare related entities.

### BACKGROUND

For many years, the mechanism for evaluating clinical processes related to a particular patient has been the medical chart or medical record. As such, for example, the medical record has been used to record patient identification, health history, medical examination and/or lab test results, medical prescriptions and other information such as, for example, orders related to the particular treatments or diagnoses associated with the patient. Accordingly, in order to assess whether a patient has received or is due to receive a particular treatment or care related event, the patient's chart would typically be reviewed. Additionally, in order to become aware of the results of various tests or treatments or to keep abreast of trends in certain indicators related to a particular condition or treatment, chart review would typically be required.

Recently, efforts have been made to move to electronic medical records (EMR). Although the EMR concept has encountered many issues in relation to, for example, cost, security, interoperability, etc., many hospitals are either employing, or planning to employ, some form of EMR. With clinical documentation systems moving to electronic media, clinical data may be available for incorporation into a number of different applications designed to assist in the management or use of such data. Computerized provider order entry (CPOE) is one example of a development that may improve the ability to electronically access information related to physician's orders. Many other applications are being developed to utilize electronic information on people and processes to manage the provision of various aspects of patient care including the provision of predictive care.

As the availability of electronic clinical data is increasing, the demand for applications that utilize such data to provide information, guidance and services is also increasing. Many applications have been developed to assist hospitals, clinics, doctors, insurance companies, and other healthcare related service providers with various aspects of improving patient care. However, since each healthcare related entity may employ its own judgment with respect to the applications it can afford or otherwise desires to utilize, a wide variety of applications with differing patient identification mechanisms, registration event tracking mechanisms and billing procedures may be employed within even a single healthcare related entity, much less over a cross section of different healthcare related entities.

As such, because patients often see different healthcare related entities, even potentially in relation to a single health problem, it may be extremely difficult to reconcile even the identity of patients among the different healthcare related entities. Reconciling and coordinating registration events may prove even more difficult than reconciling identities.

Accordingly, it may be desirable to provide an improved mechanism by which coordination of registration events within a healthcare system, and across multiple healthcare systems, may be provided.

### BRIEF SUMMARY

A method, apparatus and computer program product are therefore provided to enable the provision of coordination of registration events for healthcare systems nationwide.

In one exemplary embodiment, a method for providing distributed identity management is provided. The method includes receiving, from a first health system entity, an indication of a healthcare registration event intended to register a patient for an event at a second health system entity in which the patient has a first patient identifier associated with the first health system entity, providing a second patient identifier associated with the second health system entity that correlates to the first patient identifier, and coordinating, via processing circuitry, registration of the second patient identifier for the registration event with the second health system entity.

In another exemplary embodiment, a computer program product for providing distributed identity management is provided. The computer program product may include at least one computer-readable storage medium having computer-executable program code instructions stored therein. The computer-executable program code instructions may include program code instructions for receiving, from a first health system entity, an indication of a healthcare registration event intended to register a patient for an event at a second health system entity in which the patient has a first patient identifier associated with the first health system entity, providing a second patient identifier associated with the second health system entity that correlates to the first patient identifier, and coordinating, via processing circuitry, registration of the second patient identifier for the registration event with the second health system entity.

In another exemplary embodiment, an apparatus for providing distributed identity management is provided. The apparatus may include processing circuitry. The processing circuitry may be configured for receiving, from a first health system entity, an indication of a healthcare registration event intended to register a patient for an event at a second health system entity in which the patient has a first patient identifier associated with the first health system entity, providing a second patient identifier associated with the second health system entity that correlates to the first patient identifier, and coordinating, via processing circuitry, registration of the second patient identifier for the registration event with the second health system entity.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for providing distributed identity management according to an exemplary embodiment of the present invention;

FIG. 2 is a block diagram showing various components that may be included in an apparatus for providing distributed identity management according to an exemplary embodiment of the present invention;

FIG. 3 illustrates a communication flow diagram showing data flow for front end and backend processing associated with an exemplary embodiment of the present invention; and

FIG. 4 is a block diagram according to an exemplary method for providing distributed identity management according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which registration events may be coordinated across a global health system network. In order to provide such coordination, embodiments of the present invention may provide a network identity manager configured to match health system patients within the systems of different health system entities to provide accurate coordination of patient identities. Having accurate coordination of patient identities, embodiments of the present invention may then further provide coordination of the registration events that are associated with various ones of the patient identities. Accordingly, not only can different health system entities coordinate patient identities, but registration events associated with a particular patient may be coordinated between the health system entities so that information associated with orders, lab or test results, billing and other services may be more easily exchanged between health system entities.

As an example, a patient entering a particular health system entity (e.g., a hospital) in association with a particular ailment may be registered for any events that are to be conducted for treatment and/or follow-up care. Accordingly, a patient identity will either be created at the particular health system identity, or an existing patient identity corresponding to the patient will be identified. The patient will then be registered for each event that is to occur in association with the visit. Each such registration event for this encounter will define a corresponding activity associated with the patient. The registration events may include clinical and financial events. Thus, for example, the patient's insurance information may be entered or verified to determine how payment will be made and/or registrations may be completed for lab or imaging work that may be associated with the treatment of the patient.

As another, more specific example, a patient that is to be treated for a condition that may require events such as lab tests, imaging work and a surgical procedure, each of which may occur at a different health system entity, may have registration events associated with the treatment coordinated between the different health system entities. Thus, for example, identification of the patient and the orders and/or reporting associated with each event, along with the billing, may all be coordinated between the different health system entities performing each respective event. As such, embodiments of the present invention may enable different health system entities to coordinate patient registration events over a global health system network.

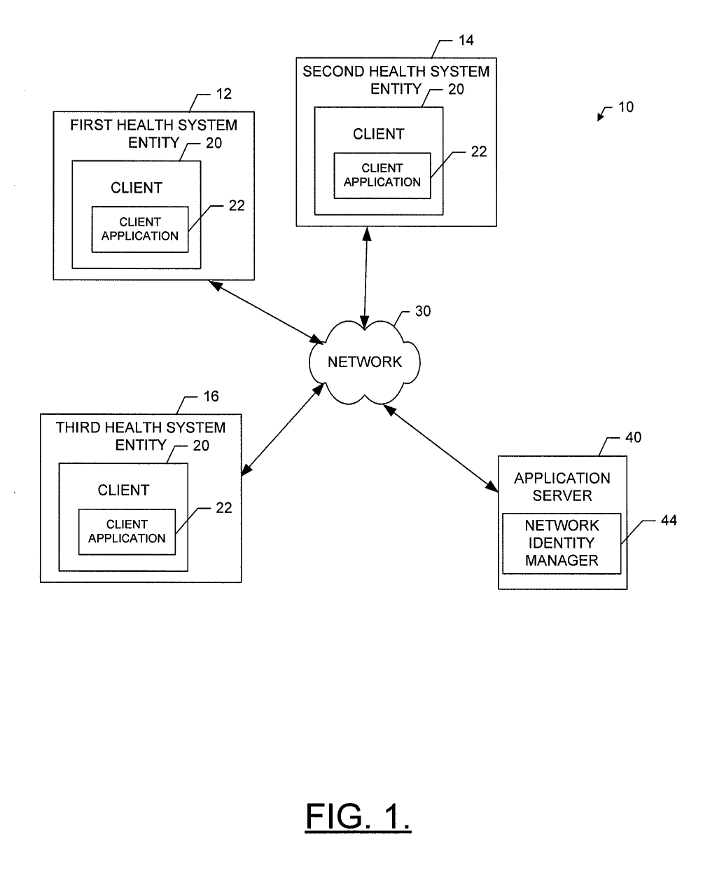

An exemplary embodiment of the invention will now be described in reference to FIG. 1, which illustrates an exemplary system in which an embodiment of the present invention may be employed. As shown in FIG. 1, a system according to an exemplary embodiment may include a plurality of health system entities forming a global health system network 10. Although FIG. 1 illustrates the global health system 10 as including three health system entities (e.g., a first health system entity 12, a second health system entity 14 and a third health system entity 16), it should be noted that the global health system may include more or less health system entities in alternative embodiments. The health system entities may be in communication (or at least capable of communication) with each other via a network 30.

In an exemplary embodiment, the health system entities may each correspond to one or more of healthcare systems, hospitals, imaging centers, laboratories, healthcare provider offices, research institutions, provider homes, insurance companies, data centers, clinics, and/or the like. Accordingly, in some cases, the health system entities may include, for example, a healthcare system, an imaging center, and/or a healthcare provider office that are all within the same geographic area. However, in other cases, the health system entities could be healthcare systems in different geographic areas. Thus, the global health system 10 may represent any scalable network of health system entities nationwide.

Each health system entity may include or otherwise be associated with one or more clients 20 that may, in some cases, be associated with managing patient identification and registration events within each respective health system entity. For example, one client 20 may be associated with the first health system entity 12 (e.g., a local hospital) and a second client 20 may be associated with the second health system entity 14 (e.g., a local imaging center). Each client 20 may be, for example, a computer (e.g., a personal computer, laptop computer, network access terminal, or the like) or may be another form of computing device (e.g., a personal digital assistant (PDA), cellular phone, or the like) capable of communication with a network 30.

As such, for example, each client 20 may include (or otherwise have access to) memory for storing instructions or applications for the performance of various functions and a corresponding processor for executing stored instructions or applications. Each client 20 may also include software and/or corresponding hardware for enabling the performance of the respective functions of the clients as described below. In an exemplary embodiment, one or more of the clients 20 may include a client application 22 configured to enable one or more of various functions including, for example, data entry, information consumption, application execution, and/or the like. In this regard, for example, the client application 22 may include software for enabling a respective one of the clients 20 to communicate with the network 30 for the provision of and receipt of information associated with various aspects of providing patient care. Thus, for example, the client application 22 may include corresponding executable instructions for configuring the client 20 to provide corresponding functionalities for the provision of and receipt of information associated with receiving patient care data, processing patient care data and/or providing patient care data as described in greater detail below. Moreover, in an exemplary embodiment, the client application 22 may include functionality, either alone or in cooperation with other applications and/or processing devices, for providing and/or requesting patient identity information and registration event information to a network identity manager configured to coordinate identity and registration event information throughout the global health system network 10. As such, in some examples, the client application 22 may include functionality associated with provision of a registration system for registering events for patients and/or a local patient identity management software suite.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an exemplary embodiment, one of the devices to which the clients 20 may be coupled via the network 30 may include one or more application servers (e.g., application server 40), which may in some cases form respective elements of a server network. Although the application server 40 is referred to as a “server”, this does not necessarily imply that the application server is embodied a single device or that the device is necessarily a server running a server operating system. As such, for example, the application server 40 may be embodied in a distributed fashion in some instances. Furthermore, the application server 40 could simply be a computer, such as a personal computer or laptop, which is configured to act in a server role with respect to providing services and information to the clients 20.

The application server 40 may include hardware and/or software for configuring the application server 40 to perform various functions. As such, for example, the application server 40 may include respective processing logic and memory enabling the application server 40 to access and/or execute stored computer readable instructions for performing various functions. In an exemplary embodiment, one function that may be provided by the application server 40 may be the provision of network identity management to enable certain patient related information to be provided to or shared between the clients 20. In this regard, for example, the application server 40 may include or otherwise be in communication with a network identity manager 44 configured to broker transactions between different clients related to registration events and patient identities. As such, data provided to the network identity manager 44 may essentially be coordinated amongst the health system identities of the global health system network 10 to enable access and manipulation to the coordinated information by the clients 20 as needed or otherwise desired.

Additionally or alternatively, the application server 40 may be configured to enable the clients 20 to provide information to the application server 40, for use by the application server 40 in producing, maintaining and/or supplying patient identity and registration event related information among other types of data. In this regard, for example, the application server 40 (or servers) may include particular applications related to various different electronic medical record modules, billing or accounting modules and other healthcare related applications. As such, some application servers and clients may host data entry mechanisms that enable the entry of patient information, treatment information, test results, medical history, orders, medications, observations, and numerous other types of information. The network identity manager 44 may thereafter broker transactions between clients and between the clients and the application server 40.

As such, the network identity manager 44 may be configured to store identity information for a plurality of patients and the stored information may be available for querying or searching with respect to a particular patient identity. Furthermore, in some examples, the network identity manager 44 may be configured to mirror or copy patient information from health system entities that are in communication with the network identity manager 44 in order to link a patient identity in one health system entity to the corresponding patient identity in another health system entity. Accordingly, for example, a patient named John Smith in the first health system entity 12 may be correlated with or otherwise linked to John C. Smith in the second health system entity 14 so that, from the perspective of the network identity manager, John Smith and John C. Smith are recognized as the same individual. Moreover, the network identity manager 44 may enable client applications 22 respectively utilized at the first health system entity 12 and the second health system entity 14 to coordinate registration events therebetween.

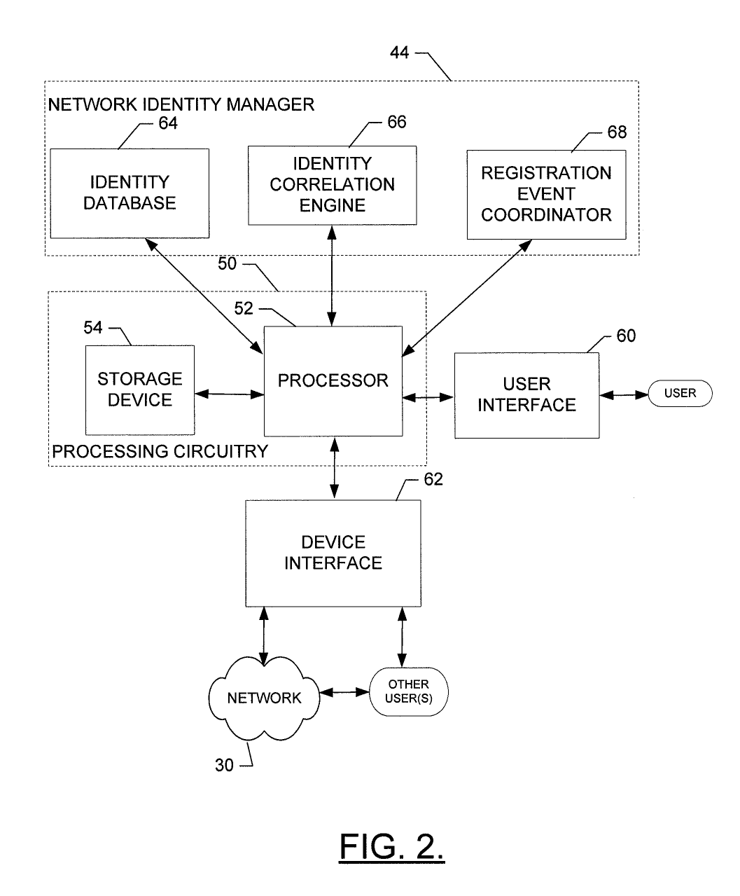

As indicated above, the network identity manager 44 may provide functionality for coordination of registration events within the network 30 to provide that information associated with registration events pertaining to a particular patient at one health system entity can be made available to another health system entity. An exemplary embodiment of the invention will now be described with reference to FIG. 2. FIG. 2 shows certain elements of an apparatus for providing network identity and registration event coordination according to an exemplary embodiment. The apparatus of FIG. 2 may be employed, for example, on a variety of devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for providing network identity and registration event coordination is illustrated by way of example. The apparatus may include or otherwise be in communication with processing circuitry 50 that is configured to perform data processing, application execution and other processing and management services according to an exemplary embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an exemplary embodiment, the storage device 54 may include one or more memory devices such as, for example, volatile and/or non-volatile memory that may be either fixed or removable. The storage device 54 may be configured to store information, data, applications, instructions or the like for enabling the apparatus to carry out various functions in accordance with exemplary embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., of the database server 42) that may store a variety of files, contents or data sets. Among the contents of the storage device 54, applications (e.g., the rational range transform manager 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an exemplary embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an exemplary embodiment, the processor 52 (or the processing circuitry 50) may be embodied as, include or otherwise control the network identity manager 44, which may include, be in communication with, or in some cases control an identity database 64, an identity correlation engine 66 and registration event coordinator 68. The example of FIG. 2 shows the identity database 64, the identity correlation engine 66 and the registration event coordinator 68 each being a portion of the network identity manager 44. However, in some cases, one or more of the identity database 64, the identity correlation engine 66 and the registration event coordinator 68 may be separate devices from the network identity manager 44.

The identity correlation engine 66 and the registration event coordinator 68 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the identity correlation engine 66 and the registration event coordinator 68, respectively, as described below.

The identity database 64 may include a listing of patient identifiers and, in some cases, links between patient identifiers associated with different health system entities. In an exemplary embodiment, the identity database 64 may be a portion of the storage device 54. However, the identity database 64 could alternatively be associated with another memory location associated with or otherwise accessible to the network identity manager 44. In some cases, the identity database 64 may be pre-populated with patient identity information associated with health system entities to which the network identity manager 44 is expected to communicate. However, the identity database 64 could alternatively be placed in communication (e.g., via the network 30) with other health system entities during runtime of the network identity manager 44 and the identity database 64 could then be populated with patient identity information at that time. As such, in some cases, the identity database 64 may copy patient identity information in order to mirror patient identity information associated with each health system entity to which the identity database 64 is connected.

In an exemplary embodiment, patent identity information for each respective health system entity represented may be stored separately. For example, the EMPI (Enterprise Master Patient Index) of a healthcare system and/or any index or listing of patient information associated with another health system entity may each be copied into separate virtual databases within the identity database 64 to mirror respective patient information in each health system entity with which the network identity manager 44 communicates. However, in some cases, patient identity information from different health system entities could be comingled and stored with a corresponding identifier indicating to which health system entity a particular patient identifier is associated.

The identity database 64 may be kept up to date via continuous, periodic, or routine updates. As such, updates may be provided in real time or substantially real time (e.g., via HL7 ADT messages) from each respective health system entity. Thus, for example, the creation of a new patient identifier and corresponding record at the first health system entity 12 may trigger communication from the first health system entity 12 to the network identity manager 44 in order to update the identity database 64 to reflect the addition of the new patient identifier in association with the first health system entity 12. The patient information may include any or all of a patient identifier (e.g., first and last name, full name, first and last name with middle initial, an identification number or code, and/or the like), demographic information, address information, insurance information, and/or the like. In some cases, such as for pending admissions, patient information may include known or temporary identifiers. Furthermore, in some examples, the patient information may also include known registration event information from a registration system of the corresponding health system entity (e.g., via the client application 22).

The patient identity information associated with a particular health system entity may then be compared to patient identity information associated with other health system entities by the identity correlation engine 66 to determine whether any particular patient identifier associated with one health system entity correlates to a corresponding patient identifier associated with another health system entity. As such, the identity correlation engine 66 is configured to identify patient identifiers associated with different health system entities that correspond to the same patient.

In an exemplary embodiment, the identity correlation engine 66 may be configured to utilize patient information to identify matches, or potential matches, between patient identifiers associated with respective different health system entities. In some cases, the identity correlation engine 66 may utilize matches in demographic information, address information, name or patient identifier, and/or the like to determine links between patient identifiers associated with different health system entities. As such, for example, the patient information may be compared over multiple dimensions or multiple characters and an instance of matching that exceeds a threshold (or an instance where differences are below a threshold) may be considered to be a match, or a potential match, depending on the degree of similarity between two patient identifiers. When a match is determined, a link may be provided to indicate the match. In some cases, a listing of matched patient identifiers may be stored by the identity correlation engine 66 (e.g., in the identity database 64) to provide a record of links made between respective patient identifiers. However, in other cases, a pointer may be stored in association with a particular patient identifier to point to the patient identifier of another health system entity to which the particular patient identifier is linked. Other linking mechanisms may also be provided.

Potential matches may also be recorded or otherwise reported to a user so that the user may have the opportunity to review the potential matches and select one (or more if multiple health system entity records are included) of the potential matches to link to the particular patient identifier. Accordingly, the identity database 64 may store patient information and information defining links (or potential links) between patient identifiers associated with different health system entities. The identity correlation engine 66 may facilitate linking of the patient identifiers and storage of linking information. Thus, in its populated rest state, the identity database 64 may have up to three classes of patient identifiers. The classes may include a class of patient identifiers that have at least one known match (e.g., patient identifiers that are linked), a class of patient identifiers that have at least one potential match, and a class of patient identifiers that have no potential matches. However, in some cases, only those with known matches may be indicated in the identity database 64 and all others may be considered to be patient identifiers with no matches. In this regard, patient identifiers with potential matches may, in some cases, only be determined in response to a specific query for matches for a particular patient identifier during operation of the network identity manager 44.

After the patient information of different health system entities has been stored and linked as is appropriate or possible, the identity database 64 and the identity correlation engine 66 may be available for use in responding to queries. As an alternative, linking may be performed during runtime in response to a query or in response to an attempt to coordinate registration events between different health system entities. The queries could be made locally (e.g., via the user interface 60) in an effort to facilitate patient matching. However, in other embodiments, the queries may be initiated at the respective clients 20 of one or more health system entities. In this regard, for example, if a new patient identifier is created for a new patient at the first health system entity 12, and the patient is expected to or has already had an interaction with the second health system entity 14, the client 20 of the first health system entity 12 may issue a query for matches for the new patient identifier in the second health system entity 14. The identity correlation engine 66 may receive the query and compare the new patient identifier (and any additional information associated with the new patient identifier) to patient identifiers and additional information associated with patient information stored in association with the second health system entity 14 to determine whether any matches exist. If a clear match is determined, the matching patient identifier may be returned to the client 20 by the identity correlation engine 66. However, if potential matches are determined, the identity correlation engine 66 may provide the potential matches to the client 20 so that a user at the client 20 may select a matching record from the potential matches offered. In response to selection of a matching record from among the potential matches offered, the identity correlation engine 66 may be configured to link the respective patient identifiers within the identity database 64.

As an alternative, when orders (or some other registration event) are placed for a patient at the client 20 of the first health system entity 12 for registration of the patient for an event at the second health system entity 14, a user at the client 20 of the second health system entity 14 may receive the orders and a query may be made to the identity correlation engine 66 to determine whether the patient for which the orders were placed correlates to any identities of the second health system entity 14. If a correlation has previously been made, or can be made, based on comparing information associated with patient identifiers as described above, then the registration event can be coordinated by registering the patient identifier of the second health system entity 14 that corresponds to the patient for which the orders were placed in the first health system entity 12 for any corresponding events associated with the orders. If a match cannot be made automatically, but candidates are identifiable, then a user at the second health system entity 14 may select a match from the candidates. If no match is possible, then a new patient identifier may be assigned for the patient and the new patient identifier may be registered for the corresponding event.

In some cases, a separate indicator may be provided for automatic matches (e.g., matches made by the identity correlation engine 66) and manual matches (e.g., matches made by a user from among a list of potential matches). Moreover, the matches may be modifiable in some cases. As such, if a match is later determined to be incorrect, a user may be enabled to modify the links between patient identifiers to remove incorrect links. Indications of fixed or modified links may also be provided in some cases.

In an exemplary embodiment, after links are established between patient identifiers, registration event coordination may be accomplished by the registration event coordinator 68. The registration event coordinator 68 may be configured to broker transactions between health system entities relating to registration events. For example, if the first health system entity 12 is a doctor's office that sees a patient and orders medical imaging at the second health system entity 14, which is an imaging center, the network identity manager 44 may be utilized to coordinate the registration of the patient at the imaging center for the imaging event. In other words, the network identity manager 44 may enable a party at the doctor's office to enter actionable orders at the imaging center. In order to accomplish this, the doctor's office may initially communicate with the network identity manager 44 to query as to whether a corresponding patient identifier exists at the imaging center for the patient for which the orders will be given. The network identity manager 44 may check the identity database 64 (e.g., via the identity correlation engine 66) to find a corresponding patient identifier linked to the patient to which the orders pertain. After identifying the correct patient, the registration event coordinator 68 may translate the orders from the doctor's office to the imaging center in association with the patient identity associated with the imaging center that corresponds to the patient identity for which the orders were entered at the doctor's office. Accordingly, as illustrated in the example above, the network identity manager 44 enables coordination of the registration event associated with the imaging work done on the patient. Furthermore, when the imaging has been completed and results are available, the network identity manager 44 may work in the reverse direction to that described above, to provide results to the doctor's office and perhaps initiate a registration event associated with scheduling a follow up appointment or negotiating payment for services rendered.

In an exemplary embodiment, the registration event coordinator 68 may be configured to pass orders, lab or test results, medical record data, billing or payment information and other types of information between entities for a particular patient. Thus, while patient identities are matched using the identity database 64 and the identity correlation engine 66, the registration event coordinator 68 is configured to enable coordination of registration events between health system entities for correlated patient identities. Thus, whereas other solutions for identifying corresponding patients in different master patient identity listings would typically require a manual entry of the order issued by the doctor's office into the system of the imaging center after the correct patient is identified, the registration event coordinator 68 of an exemplary embodiment of the present invention enables the orders entered at the doctor's office to be transmitted to the imaging center and to be considered actionable at the imaging center.

Although the example above related to a case where a matching patient was found at the imaging center, embodiments of the present invention may also be practiced in situations where no match is initially determined. In this regard, as described above, if potential matches are identified, the doctor's office may be provided with a listing of candidate matches from which to select. A user at the doctor's office may then select a candidate to match and the registration event coordinator 68 may communicate the orders to the imaging center for the corresponding matched candidate. In situations where no potential matches are indicated, a new patient identifier may be created at the imaging center responsive to the receipt of the orders from the doctor's office and the registration of the imaging event at the imaging center for the newly created patient may be accomplished. The new patient identifier may be created with patient information, account numbers and/or other identification information received from the doctor's office. Accordingly, the network identity manager 44 may enable actionable orders or other events to be registered at a particular location for a patient that is not even in the registration system of the particular location, responsive to the orders being generated at another location. In this regard, the network identity manager 44 may be configured to provide for the acquisition or exchange of account numbers and other identity information between health system identities prior to registration event (or order submission in the example above) identification, to enable new patient creation (or existing patient correlation) to provide a subject to which the registration event pertains in order to ensure a valid registration can be provided.

Accordingly, the registration event coordinator 68 may act as a transaction broker in order to receive orders or other registration events from one system entity that correspond to one patient identified uniquely in that system, and direct entry of the order within the registration system (e.g., via the client application 22) of another system entity in association with a patient identifier unique to the other system that corresponds to the same patient identified in the system that initiated the order. Thus, the network identity manager 44 incorporates the ability to accurately match or create health system patients across health system entities within the global health system 10 (e.g., via the identity database 64 and the identity correlation engine 66) along with the ability to provide interoperability with respect to registration events across different health system entities of the global health system 10.

In some embodiments, as indicated above, the identity database 64 may store registration event information in association with one or more patient identifiers. As such, for example, in situations where the identity database 64 is pre-populated, the pre-population may include storage of records associated with known registration events. In some embodiments, the registration event coordinator 68 may not only coordinate event registration transactions between clients associated with different health system entities, but may also maintain a record of such transactions (e.g., in the identity database 64 and/or in the storage device 54). However, in alternative embodiments, the registration event coordinator 68 may be configured to only coordinate transactions without storing any information about such transactions. In such embodiments, data associated with coordinated registration events may be stored locally at one, some or each of the health system entities involved. In some cases, all records may be maintained at the entity responsible for billing. However, recordation policies may be flexible in order to support the desires or requirements of the entities involved.

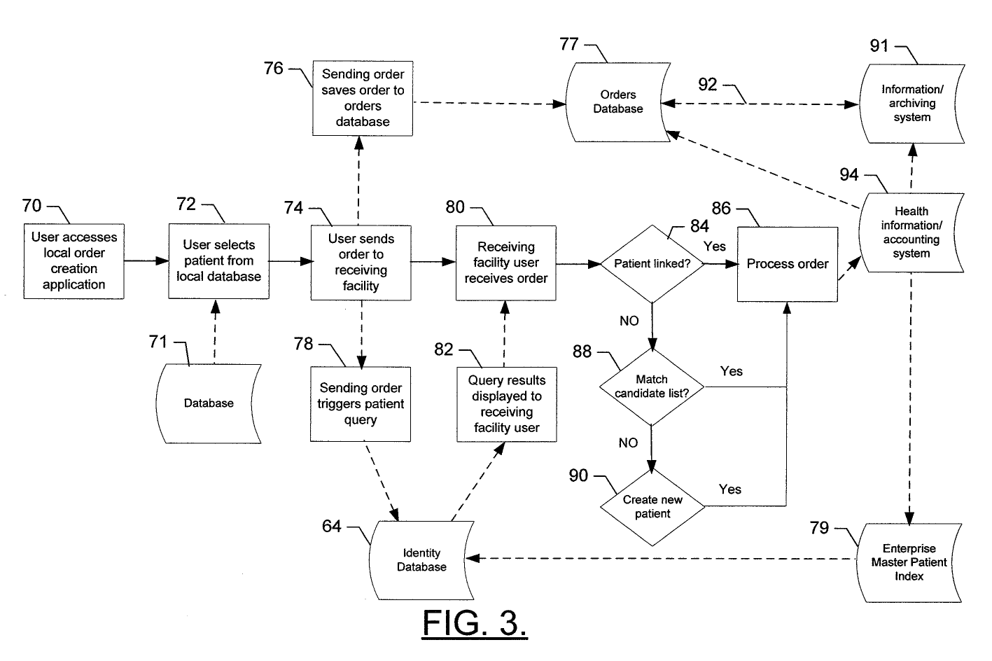

FIG. 3 is a communication flow diagram illustrating data flow for front end and backend processing associated with an exemplary embodiment of the present invention. In this regard, according to the example of FIG. 3, front end processes are shown in solid lines and backend processes are shown in solid lines. At operation 70, a user may log into access a local order creation application (e.g., client application 22). A particular patient may be selected from a local patient database (e.g., database 71) at operation 72. The user may enter an order to be sent to a receiving facility at operation 74. In some cases, the order may be saved at operation 76 to an orders database 77. The sending of the order may also trigger a patient query to the network identity manager 44 (e.g., to the identity database 64) at operation 78. The network identity manager 44 may include mirrored data regarding patient information of the receiving facility provided from an enterprise master patient index of the receiving facility 79.

At operation 80, a user at the receiving facility may receive the order sent (e.g., after logging into an application associated with network identity management). Results of the query may be displayed to the user at the receiving facility at operation 82. If the patient for which the orders were created is linked responsive to a determination in that regard at operation 84, the user at the receiving facility may process the order at operation 86. However, if a candidate list is presented and the corresponding patient can be determined from the list at operation 88, then the user at the receiving facility may process the order at operation 86. If, on the other hand, no corresponding patient can be determined from the list, then a new patient is created at operation 90 so that the user at the receiving facility may process the order at operation 86. Orders transactions may be conducted between the orders database 77 and information and/or archiving systems of the receiving facility 91 as indicated by arrow 92 responsive to instructions from a health information and/or accounting system 94.

Some embodiments of the present invention may therefore enable organizations to provide orders or other registration events to outside organizations in a relatively seamless fashion. In this regard, the network identity manager 44 provides a mechanism by which patient matches may be established for patient identifiers associated with different health system entities. Moreover, the network identity manager 44 provides a mechanisms by which one health system entity may provide registration events to another health system entity for matched or newly created patients based on the ability to provide sufficient patient identity information to permit the receiving health system entity to either match the correct patient with the registration event or create a new patient. The mechanism provided creates persistent matches that exist over time and across sources throughout the global health system 10.

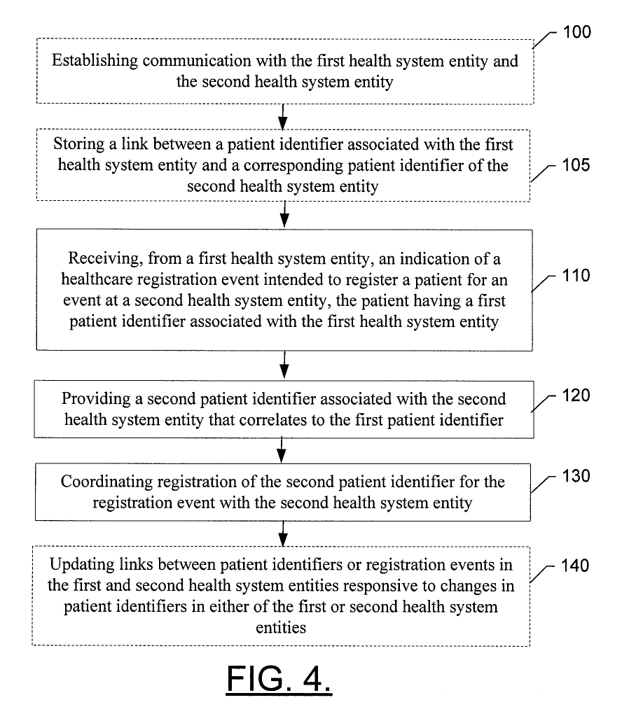

Embodiments of the present invention may therefore be practiced using an apparatus such as the one depicted in FIG. 2. However, other embodiments may be practiced in connection with a computer program product for performing embodiments of the present invention. FIG. 4 is a flowchart of a method and program product according to exemplary embodiments of the invention. Each block or step of the flowchart of FIG. 4, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s) or step(s). These computer program instructions may also be stored in a computer-readable medium comprising memory that may direct a computer or other programmable apparatus to function in a particular manner, such that the instructions stored in the computer-readable memory produce an article of manufacture including instructions to implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

In this regard, a method according to one embodiment of the invention, as shown in FIG. 4, may include receiving, from a first health system entity, an indication of a healthcare registration event intended to register a patient for an event at a second health system entity, the patient having a first patient identifier associated with the first health system entity at operation 110. The method may further include providing a second patient identifier associated with the second health system entity that correlates to the first patient identifier at operation 120. The method may further include coordinating (e.g., via processing circuitry) registration of the second patient identifier for the registration event with the second health system entity at operation 130. It should be noted that, although FIG. 4 refers to first and second health system entities, embodiments of the present invention can be practiced in connection with any number of different health system entities, each of which may be associated with the same or different aspects of patient care and, each of which may be geographically proximately located or distributed globally. Thus, a single health system entity may interact with n number of other entities to coordinate registration events for patients. Moreover, the interactions described may be repeated for any number of first health system entities initiating registration events at any number of corresponding second health system entities.

In some cases, the method may include additional optional operations, examples of which are shown in dashed lines in FIG. 4. In this regard, in an exemplary embodiment, the method may further include initial operations of establishing communication with the first health system entity and the second health system entity at operation 100 and storing a link between a patient identifier associated with the first health system entity and a corresponding patient identifier of the second health system entity at operation 105. In some embodiments, the method may include updating links between patient identifiers in the first and second health system entities responsive to changes in patient identifiers in either of the first or second health system entities at operation 140.

In some embodiments, various ones of the operations described above may be modified. The modifications may generally occur in any combination and in any order. In this regard, for example, providing the second patient identifier associated with the second health system entity may include generating a new patient identifier at the second health system entity in response to a determination that no existing patient identifier of the second health system entity correlates to the first patient identifier. Alternatively, providing the second patient identifier associated with the second health system entity may include determining whether a link is recorded between the first patient identifier and the second patient identifier and identifying the second patient identifier linked to the first patient identifier. As yet another alternative, providing the second patient identifier associated with the second health system entity comprises receiving a selection from a user at the second health system entity selecting one of a plurality of potential matches to the first patient identifier and providing the selected potential match as the second patient identifier. In some embodiments, coordinating registration of the second patient identifier may include, responsive to receiving the indication, directing registering of the event in a registration system of the second health system entity in association with the second patient identifier.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing distributed registration management comprising:
receiving, from a first health system entity, an indication of a healthcare registration event intended to register a patient for an event at a second health system entity, the patient having a first patient identifier associated with the first health system entity;
providing a second patient identifier associated with the second health system entity that correlates to the first patient identifier; and
coordinating, via processing circuitry, registration of the second patient identifier for the registration event with the second health system entity.

2. The method of claim 1, wherein providing the second patient identifier associated with the second health system entity comprises generating a new patient identifier at the second health system entity in response to a determination that no existing patient identifier of the second health system entity correlates to the first patient identifier.

3. The method of claim 1, wherein providing the second patient identifier associated with the second health system entity comprises determining whether a link is recorded between the first patient identifier and the second patient identifier and identifying the second patient identifier linked to the first patient identifier.

4. The method of claim 1, wherein providing the second patient identifier associated with the second health system entity comprises receiving a selection from a user at the second health system entity selecting one of a plurality of potential matches to the first patient identifier and providing the selected potential match as the second patient identifier.

5. The method of claim 1, wherein coordinating registration of the second patient identifier comprises, responsive to receiving the indication, directing registering of the event in a registration system of the second health system entity in association with the second patient identifier.

6. The method of claim 1, further comprising:
establishing communication with the first health system entity and the second health system entity; and
storing a link between a patient identifier associated with the first health system entity and a corresponding patient identifier of the second health system entity.

7. The method of claim 6, further comprising updating links between patient identifiers or links between registration events in the first and second health system entities responsive to changes in patient identifiers in either of the first or second health system entities.

8. A computer program product for providing distributed registration management, the computer program product comprising at least one computer-readable storage medium having computer-executable program code instructions stored therein, the computer-executable program code instructions comprising:
program code instructions for receiving, from a first health system entity, an indication of a healthcare registration event intended to register a patient for an event at a second health system entity, the patient having a first patient identifier associated with the first health system entity;
program code instructions for providing a second patient identifier associated with the second health system entity that correlates to the first patient identifier; and
program code instructions for coordinating registration of the second patient identifier for the registration event with the second health system entity.

9. The computer program product of claim 8, wherein program code instructions for providing the second patient identifier associated with the second health system entity include instructions for generating a new patient identifier at the second health system entity in response to a determination that no existing patient identifier of the second health system entity correlates to the first patient identifier.

10. The computer program product of claim 8, wherein program code instructions for providing the second patient identifier associated with the second health system entity include instructions for determining whether a link is recorded between the first patient identifier and the second patient identifier and identifying the second patient identifier linked to the first patient identifier.

11. The computer program product of claim 8, wherein program code instructions for providing the second patient identifier associated with the second health system entity include instructions for receiving a selection from a user at the second health system entity selecting one of a plurality of potential matches to the first patient identifier and providing the selected potential match as the second patient identifier.

12. The computer program product of claim 8, wherein program code instructions for coordinating registration of the second patient identifier include instructions for, responsive to receiving the indication, directing registering of the event in a registration system of the second health system entity in association with the second patient identifier.

13. The computer program product of claim 8, further comprising:
establishing communication with the first health system entity and the second health system entity; and
storing a link between a patient identifier associated with the first health system entity and a corresponding patient identifier of the second health system entity.

14. An apparatus for providing a distributed registration manager comprising processing circuitry configured to:
receive, from a first health system entity, an indication of a healthcare registration event intended to register a patient for an event at a second health system entity, the patient having a first patient identifier associated with the first health system entity;
provide a second patient identifier associated with the second health system entity that correlates to the first patient identifier; and
coordinate registration of the second patient identifier for the registration event with the second health system entity.

15. The apparatus of claim 14, wherein the processing circuitry is configured to provide the second patient identifier associated with the second health system entity by generating a new patient identifier at the second health system entity in response to a determination that no existing patient identifier of the second health system entity correlates to the first patient identifier.

16. The apparatus of claim 14, wherein the processing circuitry is configured to provide the second patient identifier associated with the second health system entity by determining whether a link is recorded between the first patient identifier and the second patient identifier and identifying the second patient identifier linked to the first patient identifier.

17. The apparatus of claim 14, wherein the processing circuitry is configured to provide the second patient identifier associated with the second health system entity by receiving a selection from a user at the second health system entity selecting one of a plurality of potential matches to the first patient identifier and providing the selected potential match as the second patient identifier.

18. The apparatus of claim 14, wherein the processing circuitry is configured to coordinate registration of the second patient identifier by, responsive to receiving the indication, directing registering of the event in a registration system of the second health system entity in association with the second patient identifier.

19. The apparatus of claim 14, wherein the processing circuitry is further configured to:
establish communication with the first health system entity and the second health system entity; and
store a link between a patient identifier associated with the first health system entity and a corresponding patient identifier of the second health system entity.

20. The apparatus of claim 19, wherein the processing circuitry is further configured to update links between patient identifiers or links between registration events in the first and second health system entities responsive to changes in patient identifiers in either of the first or second health system entities.
